(19) United States
(12) Patent Application Publication
(10) Pub. No.: US 2011/0108062 A1
(43) Pub. Date: May 12, 2011

(54) METHOD OF WASHING A GAS TURBINE ENGINE

(76) Inventors: Roy L. Stone, Springboro, OH (US); Donna E. Gerber, Mason, OH (US); Kunio Masuda, West Chester, OH (US); David G. Blanchette, Hamersville, OH (US); Michael D. Fullington, West Chester, OH (US)

(21) Appl. No.: 12/612,355

(22) Filed: Nov. 4, 2009

Related U.S. Application Data
(60) Provisional application No. 61/112,080, filed on Nov. 6, 2008.

(51) Int. Cl. B08B 3/04

(52) U.S. Cl. 134/10

(57) ABSTRACT

A method of washing a gas turbine engine, the method comprising the steps of: providing a gas turbine engine, the engine having an intake and an exhaust, the exhaust having an inner surface and an outer surface; providing a system for washing gas turbine engines, the system including a containment structure; releasably securing the containment structure to the inner surface via a retaining ring; introducing a wash liquid into the intake; and collecting the wash liquid in the containment structure.

### CROSS-REFERENCE TO RELATED APPLICATION

This application claims priority to U.S. Provisional Application Ser. No. 61/112,080, filed Nov. 6, 2008.

### BACKGROUND OF THE INVENTION

The technology described herein relates generally to gas turbine engines, and more particularly, to a system and method for washing gas turbine engines and a method for determining a wash interval for gas turbine engines.

At least one known gas turbine engine assembly includes a fan assembly that is mounted upstream from a core gas turbine engine. During operation, a portion of the airflow discharged from the fan assembly is channeled downstream to the core gas turbine engine wherein the airflow is further compressed. The compressed airflow is then channeled into a combustor, mixed with fuel, and ignited to generate hot combustion gases. The combustion gases are then channeled to a turbine, which extracts energy from the combustion gases for powering the compressor, as well as producing useful work to propel an aircraft in flight. The other portion of the airflow discharged from the fan assembly exits the engine through a fan stream nozzle.

In operation, particularly when the aircraft is near the ground such as during takeoff and landing operations, the gas turbine engine may ingest various forms of foreign material such as dust, dirt, insects, etc. Even though such material may be small enough in size, or sufficiently frangible, to pass into and through the engine without damage, such materials may leave behind residue on internal surfaces within the engine. Combustion by-products passing through the engine and oxidation of various components may also create or leave behind residue on internal engine surfaces. Over time, such residue can build up and have a negative effect upon engine performance

Various systems and methods have been developed to “wash” or cleanse the internal surfaces of such gas turbine engines with a wash solution, thereby removing residue, to restore performance. However, many such systems are cumbersome to use, involving many components and/or large flexible structures to enclose the engine being washed. Many systems also fail to adequately capture residue and wash solution after use, leading to loss of solution for reuse and contamination of external environmental surfaces with residue and wash solution.

Therefore, there remains a need for an improved system and method for washing gas turbine engines which provides improved capture of residue and wash solution.

In addition, many operators of gas turbine engines rely on published recommendations based on operating conditions or operating duration to determine when it is necessary to wash the engine. Others perform wash operations based on some operating rhythm or frequency. Still others rely on some change in engine performance levels. However, such methods of determining when a wash is needed may result in overperforming or underperforming wash operations for optimum performance

Therefore, there remains a need for an improved method of determining when engine washing is needed for optimum performance

### BRIEF SUMMARY OF THE INVENTION

In one aspect, a method of washing a gas turbine engine is described, the method comprising the steps of: providing a gas turbine engine, the engine having an intake and an exhaust, the exhaust having an inner surface and an outer surface; providing a system for washing gas turbine engines, the system including a containment structure; releasably securing the containment structure to the inner surface via a retaining ring; introducing a wash liquid into the intake; and collecting the wash liquid in the containment structure.

### BRIEF DESCRIPTION OF THE DRAWINGS

FIG. 1 is a elevational side view of an exemplary gas turbine engine and engine wash system;

FIG. 2 is a top plan view of the gas turbine engine and engine wash system shown in FIG. 1;

FIG. 3 is an elevational cross-sectional view of the engine wash system shown in FIG. 1 taken along line 3-3, illustrating the primary mist collector; and

FIG. 4 is an exploded view of a mist collector suitable for use in the engine wash system illustrated in FIGS. 1-3.

### DETAILED DESCRIPTION OF THE INVENTION

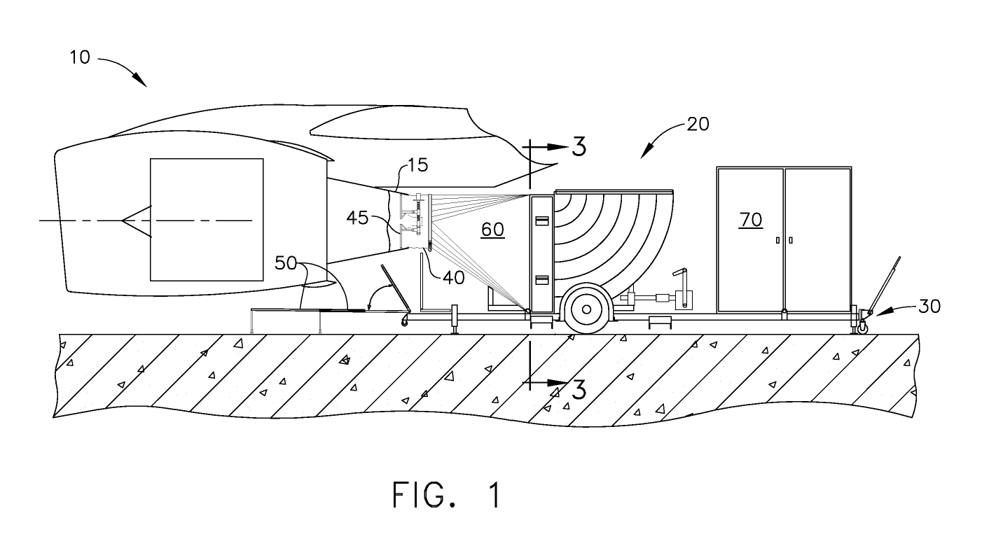

FIG. 1 is an elevational view of an exemplary gas turbine engine assembly 10 having a longitudinal axis. Gas turbine engine assembly 10 includes a fan assembly and a core gas turbine engine. The core gas turbine engine includes a high pressure compressor, a combustor, and a high pressure turbine. In the exemplary embodiment, gas turbine engine assembly 10 also includes a low pressure turbine, a multi-stage booster compressor, and a splitter that substantially circumscribes the booster.

The fan assembly includes an array of fan blades extending radially outward from a rotor disk. Gas turbine engine assembly 10 has an intake side and an exhaust side. Fan assembly, booster, and turbine are coupled together by a first rotor shaft, and compressor and turbine are coupled together by a second rotor shaft.

In operation, air flows through the fan assembly and a first portion of the airflow is channeled through the booster. The compressed air that is discharged from the booster is channeled through the compressor wherein the airflow is further compressed and delivered to the combustor. Hot products of combustion from the combustor are utilized to drive the turbines, and one turbine is utilized to drive the fan assembly and the booster by way of a shaft. The first portion of the airflow along with the combustion products are exhausted to the atmosphere via nozzle 15. Gas turbine engine assembly 10 is operable at a range of operating conditions between design operating conditions and off-design operating conditions.

A second portion of the airflow discharged from the fan assembly is channeled through a bypass duct to bypass a portion of the airflow from the fan assembly around the core gas turbine engine. More specifically, the bypass duct extends between a fan casing or shroud and splitter. Accordingly, a first portion of the airflow from the fan assembly is channeled through the booster and then into the compressor as described above, and a second portion of the airflow from the fan assembly is channeled through the bypass duct to provide thrust for an aircraft, for example. Gas turbine engine assembly 10 also includes a fan frame assembly to provide structural support for fan assembly and is also utilized to couple the fan assembly to the core gas turbine engine.

Also shown in FIG. 1 is engine wash system 20. Engine wash system 20, shown in the form of an exemplary Water Wash Trailer (WWT) unit, includes a trailer 30 or other suitable means of transportation, a flexible boot 40, a ring clamp 45, capture devices 50 such as drip pans, a collection system 60, an optional storage cabinet 70, and a wash liquid injection system (not shown) which can be a commercially available system.

The engine wash system 20 is designed to collect the waste water and engine exhaust particles from the exhaust nozzle 15 during the performance of an engine wash operation while the gas turbine engine assembly 10 remains installed on the aircraft. Emerging from the gas turbine engine is typically a combination of gaseous, liquid, and solid material, such as air, water or cleaning solution, and particulate material.

The flexible boot 40 is installed inside the exhaust nozzle 15 via a retaining ring in the form of a ring clamp 45, which is an internal ring clamp specially designed for this purpose and sized and configured to engage the inner surface of the exhaust nozzle 15. Ring clamp 45 thus enables the flexible boot to be secured to the exhaust nozzle without requiring any additional hardware or any specially designed features on the gas turbine engine assembly 10. To secure the boot 40 to the nozzle 15, the ring clamp 45 is reduced in size to a smaller diameter than that of the exhaust nozzle 15 and inserted into the nozzle 15 a sufficient distance, such as, for example, about 3 inches from the outlet of the exhaust nozzle 15. The ring clamp 45 is then expanded by any suitable mechanism, such as hand crank screws shown in the embodiment of FIG. 1, ensuring contact between the flexible boot 40 and the interior surface of the nozzle 15 around their circumference. This engagement ensures positive sealing engagement to aid in ensuring a high capture rate for exhaust air leaving nozzle 15. The ring clamp or retaining ring may also be variable in shape in addition to or instead of size in order to permit insertion into the exhaust nozzle and then engagement with the inner surface of the nozzle.

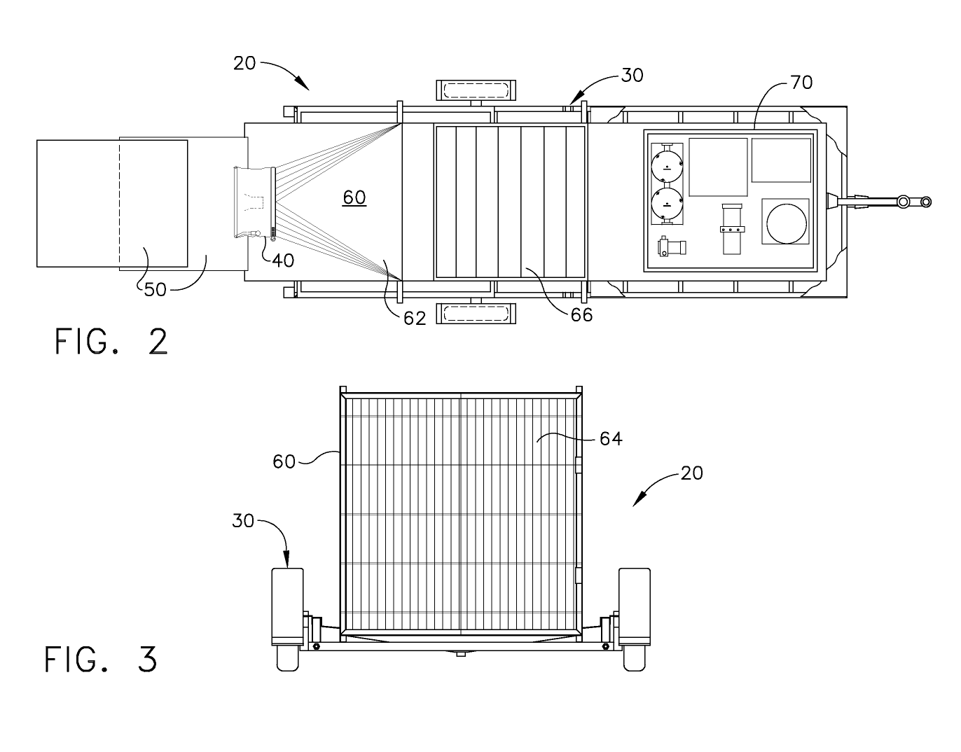

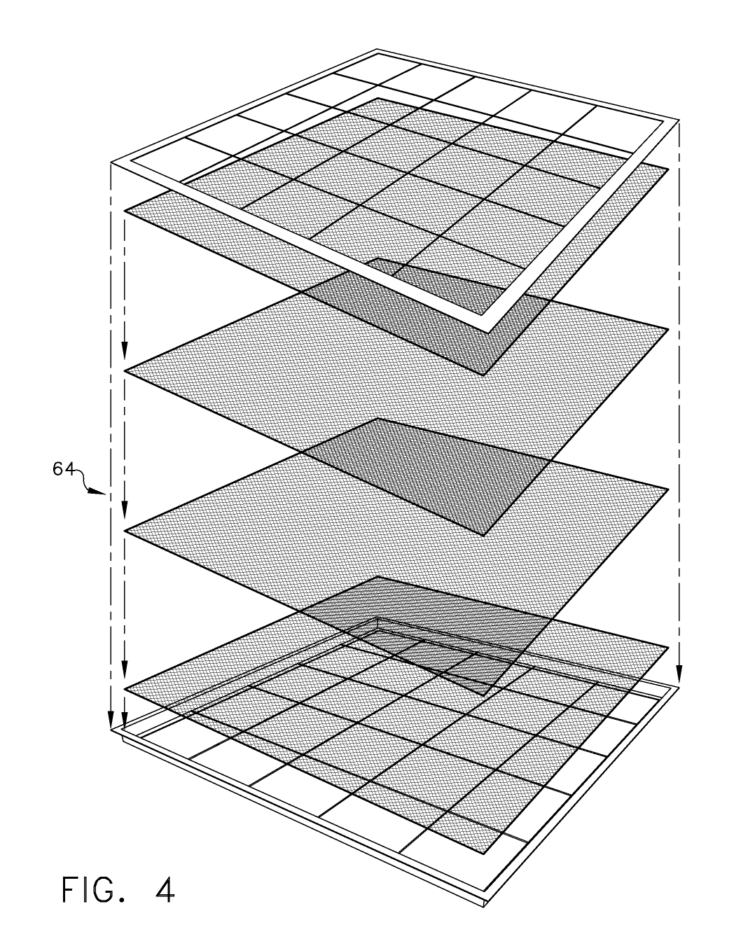

Collection system 60 includes features which aid in the capture and collection of the wash fluid and materials removed from the gas turbine engine assembly 10. As shown in FIGS. 1-3, the collection system 60 includes a water collection transition plenum 62 which serves as an expansion chamber to decelerate the air and liquid droplets exiting from the nozzle 15, as well as both primary and secondary mist collectors 64 and 66, respectively. Primary mist collector 64 is designed to intercept the water or fluid mist from the exhaust air, and the secondary mist collector 66 is designed to capture any mist or droplets which pass the primary mist collector 64. FIG. 3 illustrates in greater detail one suitable structure for use as a mist collector 64 and/or 66, although a wide variety of other structures may prove suitable. Mist collectors can be single layer structures, or multilayer structures such as shown in FIG. 3.

The physical details of the engine wash system 20, including the size and shape of various elements, may be adapted for use with one or more specific configurations of gas turbine engine assembly 10. Additionally, the wash fluid may be selected for particular cleaning characteristics and atmospheric environments such as temperature. Under some circumstances, ordinary water from a municipal water supply or other source may be utilized, while in other circumstances a mixture of water and a cleansing agent such as detergent may be utilized. A mixture of water and alcohol may be utilized for engine wash operations in low temperature conditions. The wash fluid may also be heated if desired.

Engine wash system 20 may be a fully self-contained unit, which both dispenses and collects the cleaning fluid, or may be a collection unit which relies upon a separate and independently furnished and/or operated cleaning fluid dispensing system such as those currently commercially available. A collection type unit typically includes a suction pump for removing collected liquid from the collection system, a filter for removing particulate material and/or cleaning solution from the water, and a storage tank of sufficient capacity, such as for example 60 gallons, to hold the volume of water used in a typical engine wash procedure. A fully self-contained unit would include the supply and dispensing equipment, including heaters or other pre-process equipment, as well as the collection features described above.

Other optional features which may be included are a detergent filtration system, a cold water storage tank, a hot water tank with heater, a detergent tank, a high pressure pump for injection purposes, a manual selector valve for selecting between the water tank or the detergent tank, pressure relieve valve, and solution injection tubes (often in the form of a Shephard's cane).

The transition plenum 62, constructed of a suitable material such as stainless steel, captures the water mist from the exhaust nozzle 15 and collects the used wash water or fluid. The plenum is designed such that the air exhausted from the nozzle 15 will expand into the plenum and reduce the air velocity, thus enhancing the likelihood of capturing the water mist and particles. The plenum and/or collection system may include vanes for turning and/or slowing the airflow to aid in the separation of liquid. The waste water drains down into a drip pan 50, one or more of which serve to capture and collect any minor amounts of wash water or fluid which may escape from the gas turbine engine assembly 10 or various elements of the engine wash system 20.

A pump, such as a self-priming pump, may be utilized for transferring the used wash water or fluid into the storage tank, optionally through a water filtration system. Suitable filters may be provided to filter the used wash water or fluid to the desired standards, including removal of particulate materials of specified size, such as 1 micron. One or more water tanks of suitable size may be provided to store filtered water for further use or later disposal.

Trailer 30 provides a convenient mechanism for supporting, storing, and organizing the various elements of the engine wash system 20. A lift mechanism (not shown) may optionally be provided as part of the engine wash system 20 and/or the trailer 30. Such a lift mechanism may be used to position the elements of the engine wash system 20 at the desired height for use with various aircraft and gas turbine assembly configurations. Such a lift mechanism may be an integral part of the engine wash system 20 or may be a separate vehicle or mechanism, and may include hydraulic pumps, electric motors, and associated manifolds, valves, piping, and check valves or may be mechanically operated and supported. Suitable lift mechanisms are designed and configured to support the elements of the engine wash system 20 and may include safety features such as locks, braces, and the like to ensure safe operation. A lift mechanism or other mechanical, pneumatic, or hydraulic mechanism may be provided for adjusting the alignment of the plenum, boot, or other elements of the system and may be manually operated via hand crank or otherwise, or be powered by electric motors or other devices.

Other elements which may be included in or used on conjunction with the engine wash system 20 include a generator to provide electrical power for the system, a vacuum cleaner or other such suction generating device to vacuum out and collect any residual water from the exhaust nozzle, and a grounding wire to connect to a suitable electrical grounding device at the operating location.

In preparation for operation, the water wash procedures from the Aircraft Operation Manual and/or Aircraft Maintenance Manual should be consulted for each type of aircraft upon which the engine wash procedure is to be performed. One important consideration is that the gas turbine engine should be operated in “dry motoring” mode, wherein the components of the core of the gas turbine engine are rotated by the engine starter without any fuel being supplied to the fuel system (fuel nozzles, etc.). This is in contrast to “wet motoring”, which is the same as “dry motoring” but with fuel being supplied to the fuel system, and “ground idle”, wherein the gas turbine has been started and is operating under its own power, typically the slowest idle speed for sustained operation on the ground.

Prior to operating the engine wash system, the following steps are recommended: Inspect for damage in shipment, remove and store the covers, inspect once again for damage or unusual events, open the doors to the storage enclosure to ensure the gasoline tank for the generator is filled, check the hydraulic system for leaks, and ensure the cylinders are in the proper position and the switches are off. Meanwhile, have the aircraft operator run the gas turbine engine at ground idle for about 5 minutes, or otherwise as recommended by the aircraft maintenance manual, stop the engine, and locate the engine wash system trailer behind the engine centerline and approach the engine manually until the plenum inlet is approximately 3 feet away from the nozzle exit. Ensuring the centerlines of the engine and plenum are aligned, slowly move the trailer closer until the plenum inlet is approximately 20 inches away from the exhaust nozzle exit plane. The flexible boot can then be secured to the engine exhaust nozzle via the retainer ring and the remainder of the wash sequence performed.

To maximize the benefits of a water wash program for gas turbine engines, the wash process should be performed at a time and on a time interval when the wash will provide the desired performance benefit while balancing the cost and time of the wash process itself

In order to determine when is the appropriate time, and the appropriate time interval, for performing an engine wash operation on a given gas turbine engine, the following method may be employed comprising the steps of: measuring engine performance data for a gas turbine engine, the gas turbine engine being part of a regional operating fleet and an engine family operating fleet; calculating average performance data for the regional operating fleet; calculating average performance data for the engine family operating fleet; comparing the engine performance data for said gas turbine engine to the average data for the regional operating fleet; and indicating a need to wash the gas turbine engine when the comparing step reveals diminished performance of the gas turbine engine.

This overall method for determining when to wash may be further refined through a more detailed method, such as the one described below.

Such a more detailed method for determining the appropriate time and appropriate time interval for performing an engine wash operation on a given gas turbine engine comprises the steps of: measuring engine performance data for a gas turbine engine, the gas turbine engine being part of a regional operating fleet and an engine family operating fleet; calculating key engine performance characteristics from measured data and from engine manufacturer development and testing throughout the engine life cycle; calculating average fleet rates of change in key performance characteristics derived from engine manufacturer algorithms and modeling for unwashed and washed engines; calculating average wash benefit retention time based on key engine manufacturer-developed performance characteristics and their rates of change based on fleet data and operational considerations; collecting average block fuel burn data for the specific regional operating fleet; calculating other cost of ownership metrics influenced by engine wash, including impacts on maintenance costs and overhaul intervals; collecting fuel cost and engine wash cost data for the specific regional operating fleet; and calculating an optimum wash interval based on economic cost benefit analysis for the specific regional operating fleet customized for an individual, unique airline.

These methods may be refined as desired through additional considerations such as aircraft type, engine model, and flight characteristics such as flight duration and distance. For example, such calculations can be made using only data pertaining to a single aircraft type, a single engine model, or for a fleet or sub-fleet having the same flight duration and/or distance.

The containment structure and other elements of the engine wash system may be fabricated from any suitable materials using any suitable fabrication methods as are known in the art and suitable for the intended configuration and operating environment. Likewise, any suitable liquids may be utilized as the wash fluid, including water, detergent, and/or various solvents. The size, shape, and arrangement of the various elements of the system may be adapted to suit any particular application, or any particular consideration such as storage space, transportability, etc.

While the invention has been described in terms of various specific embodiments, those skilled in the art will recognize that the invention can be practiced with modification within the spirit and scope of the claims.

1. A method of washing a gas turbine engine, said method comprising the steps of:
providing a gas turbine engine, said engine having an intake and an exhaust, said exhaust having an inner surface and an outer surface;
providing a system for washing gas turbine engines, said system including a containment structure;
releasably securing said containment structure to said inner surface via a retaining ring;
introducing a wash liquid into said intake; and
collecting said wash liquid in said containment structure.

2. A method in accordance with claim 1, wherein said containment structure includes an expansion chamber.

3. A method in accordance with claim 1, further comprising a flexible boot for connecting said containment structure to said exhaust.

4. A method of washing a gas turbine engine, said method comprising the steps of:
providing a gas turbine engine, said engine having an intake and an exhaust nozzle, said exhaust nozzle having an inner surface and an outer surface;
providing a system for washing gas turbine engines, said system including a containment structure having an expansion chamber;
releasably securing said containment structure to said inner surface via a flexible boot secured by a retaining ring;
introducing a wash liquid into said intake; and
collecting said wash liquid in said containment structure.

5. A method of determining when to wash a gas turbine engine, said method comprising the steps of:
measuring engine performance data for a gas turbine engine, said gas turbine engine being part of a regional operating fleet and an engine family operating fleet;
calculating average performance data for said regional operating fleet;
calculating average performance data for said engine family operating fleet;
comparing said engine performance data for said gas turbine engine to said average data for said regional operating fleet; and
indicating a need to wash said gas turbine engine when said comparing step reveals diminished performance of said gas turbine engine.

6. A method in accordance with claim 5, wherein said data pertains to a single gas turbine engine model.

7. A method in accordance with claim 5, wherein said regional operating fleet and said engine family operating fleet comprise a single type of aircraft.

8. A method of determining an optimum wash interval to wash a gas turbine engine, said method comprising the steps of:
measuring engine performance data for a gas turbine engine, said gas turbine engine being part of a regional operating fleet and an engine family operating fleet;
calculating key engine performance characteristics for said gas turbine engine from measured data and from engine manufacturer development and testing throughout the life cycle of said gas turbine engine;
calculating average fleet rates of change in key performance characteristics derived from engine manufacturer algorithms and modeling for unwashed and washed engines;
calculating an average wash benefit retention time based on key engine manufacturer-developed performance characteristics for said gas turbine engine and their rates of change based on fleet data and operational considerations;
collecting average block fuel burn data for said specific regional operating fleet;
calculating other cost of ownership metrics influenced by engine wash, including impacts on maintenance costs and overhaul intervals;
collecting fuel cost and engine wash cost data for said specific regional operating fleet; and
calculating an optimum wash interval based on economic cost benefit analysis for said specific regional operating fleet customized for an individual, unique airline.

9. A method in accordance with claim 8, wherein said data pertains to a single gas turbine engine model.

10. A method in accordance with claim 8, wherein said regional operating fleet and said engine family operating fleet comprise a single type of aircraft.
